(19) United States
(12) Patent Application Publication
(10) Pub. No.: US 2012/0118335 A1
(43) Pub. Date: May 17, 2012

(54) PRESSURE WASH SYSTEM

(76) Inventor: Dean Gillingham, Beaverlodge (CA)

(21) Appl. No.: 12/948,670

(22) Filed: Nov. 17, 2010

(51) Int. Cl. B08B 3/00; F28D 15/00

(52) U.S. Cl. 134/105; 165/104.28

(57) ABSTRACT

A pressure wash system includes a heat exchanger having a first fluid path with an inlet and an outlet and a second fluid path with an inlet and an outlet. A heat exchange takes place between the fluids passing along the first fluid path and fluids passing along the second fluid path. A boiler water circulation loop circulates hot water from a boiler installation along the first fluid path from the inlet to the outlet. A cold water source is upstream of the inlet for the second fluid path of the heat exchanger. A spray nozzle is downstream of the outlet for the second fluid path. A pump drives water from the cold water source along the second fluid path of the heat exchanger where it is heated by a heat exchange with hot boiler water and delivered under pressure to the spray nozzle.

### FIELD

The present invention relates to pressure wash systems.

### BACKGROUND

Equipment such as drilling rigs, service rigs, gas plants, etc. require frequent cleaning by means of high velocity pressure washers. The efficacy of the pressure washers generally improves when warm water is used in place of cold water, particularly in winter when equipment and grime are frozen together. However, energy costs and availability at remote work sites has thus far prevented the use of warm water in pressure washers.

### SUMMARY

In one aspect, there is provided a pressure wash system for drilling rigs which includes a heat exchanger having a first fluid path having an inlet and an outlet and a second fluid path having an inlet and an outlet. A heat exchange takes place between the fluids passing along the first fluid path and fluids passing along the second fluid path. A boiler water circulation loop circulates hot water from a boiler installation at a drilling rig along the first fluid path from the inlet to the outlet. A cold water source is upstream of the inlet for the second fluid path of the heat exchanger. A spray nozzle is downstream of the outlet for the second fluid path. A pump drives water from the cold water source along the second fluid path of the heat exchanger where it is heated by a heat exchange with hot boiler water and delivered under pressure to the spray nozzle.

Preferably, the heat exchanger includes an elongated vertically orientated cylindrical housing having a bottom, a top, an interior cavity with a boiler water inlet and a boiler water outlet positioned to define the first fluid path through the interior cavity. A tubing core is positioned within the interior cavity of the housing defining the second fluid path. The tubing core has an inlet through which fluid is fed into the tubing core and an outlet through which fluid exits the tubing core. The second fluid path defined by the tubing core being tortuous to promote a heat exchange with the first fluid path.

Preferably, in order to readily drain the housing, the housing includes a housing drain at the bottom allowing for gravity drainage of the first fluid path.

In another aspect, there is provided a method of heating water for use with a spray nozzle on a drilling rig which includes circulating hot boiler water from a boiler installation at a drilling rig along a first fluid path of a heat exchanger, and pumping water from a cold water source along a second fluid path of the heat exchanger through a heat exchange with the hot boiler water.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a pressure wash system for drilling rigs.

FIG. 2 is a partially disassembled side elevation view of the pressure wash system for drilling rigs of FIG. 1.

### DETAILED DESCRIPTION OF THE DRAWINGS

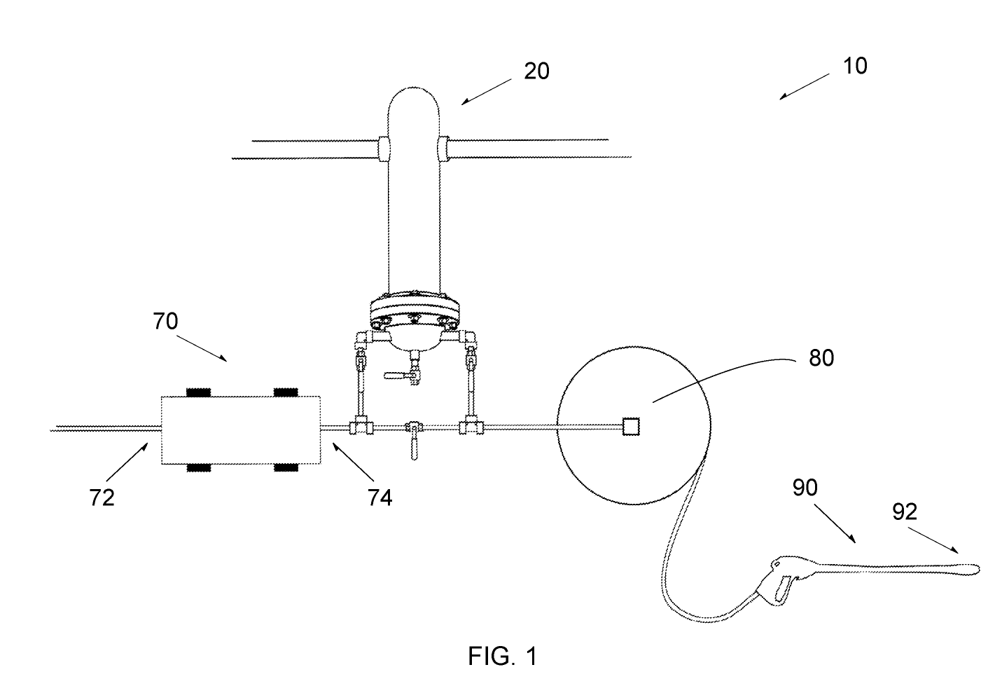

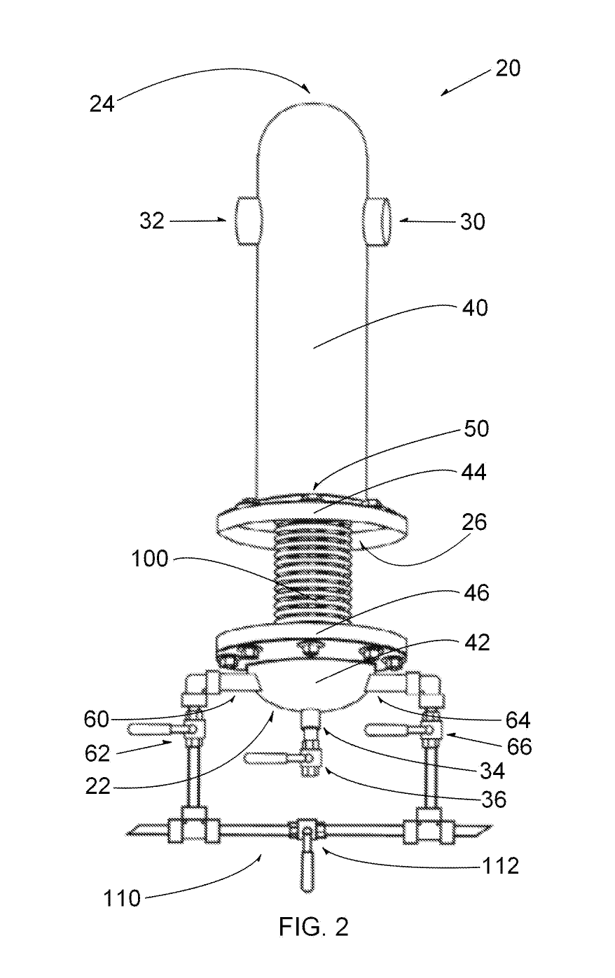

A pressure wash system generally identified by reference numeral 10, will now be described with reference to FIG. 1 and FIG. 2.

### Structure and Relationship of Parts:

Referring to FIG. 1, the pressure wash system 10 includes a vertically orientated cylindrical heat exchange housing 20. The pressure wash system 10 further includes a pressure washer 70 having a cold water inlet 72 and a cold water outlet 74. The cold water outlet 74 is connected for fluid passage to a tubing system (described in detail below) which includes the use of a hose reel 80 and is connected for fluid passage ultimately to a wash wand 90 having a spray nozzle 92.

Referring now to FIG. 2, the vertically orientated cylindrical heat exchange housing 20 includes a bottom 22, a top 24 and an interior cavity 26. Housing 20 further includes a boiler water inlet 30, a boiler water outlet 32, a housing body 40 and a housing cap 42. The housing body 40 further includes a top flange 44. The housing cap 42 further includes a bottom flange 46. The housing body 40 is removably engaged to housing cap 42 by means of bolts 50 through both top flange 44 and bottom flange 46. Housing cap 42 further includes housing drainage 34 connected for fluid passage to drainage valve 36.

Continuing to refer to FIG. 2, housing cap 42 further includes a cold water inlet 60 connected for fluid passage to a cold water valve 62 and a warm water outlet 64 connected for fluid passage to a warm water valve 66. The cold water inlet 60 is connected for fluid passage to warm water outlet 64 via a vertically oriented coiled tubing core 100. A by-pass line 110 having a by-pass valve 112 is connected for fluid passage between cold water outlet 74 (show in FIG. 1) and the wash wand 90 (shown in FIG. 1).

### Operation:

It will be appreciated after the following the description of the operation of the pressure wash system that the pressure wash system 10 converts what would otherwise be wasted energy in form of heat from a boiler installation, such as is found on site at a drilling rig, a service rig, gas plant, etc. into useable warm water for more efficacious pressure washing of a drilling rig compared to pressure washing of a drilling rig with cold water.

On-site boiler installations, such as those at drilling rigs, are used to power drilling machinery. However, the water in the boiler is too hot to be suitable for use for pressure washing the associated equipment. Instead, referring to FIG. 1 and FIG. 2, hot boiler water is circulated in and out of the interior cavity 26 of housing 20 via boiler water inlet 30 and boiler water outlet 32, respectively. Housing drainage 34 and drainage valve 36 represent means for gravity draining of interior cavity 26 during maintenance or prolonged discontinued use of the pressure wash system 10.

During normal operation, cavity 26 is constantly filled with hot boiler water circulated from the on-site boiler installation. Cold water from a cold water source enters cold water inlet 72 at a low velocity and is pressurized by pressure washer 70 to a high velocity as it leaves cold water outlet 74. The pressurized cold water travels through an open cold water valve 62, through cold water inlet 60 and into tubing core 100 towards warm water outlet 64. Heat is exchanged between the hot boiler water in cavity 26 and the pressurized cold water traveling through tubing core 100. This heat exchange is greatly enhanced by the tortuous path of tubing core 100. The pressurized water leaving warm water outlet 64 is warm. By-pass valve 112 is closed during normal operations. This warm pressurized water travels past an open warm water valve 66 ultimately to the spray nozzle 92 of wash wand 90. A user then operates wash wand 90 to clean a drilling rig. The use of hose reel 80 to manage the length of tubing required for any particular cleaning operation is preferred.

During operations where hot boiler water is unavailable or not required, cold water valve 62 and warm water valve 66 are closed. By-pass valve 112 is opened allowing pressurized cold water to travel via by-pass line 110 ultimately to the spray nozzle 92 of wash wand 90. A user then operates wash wand 90 to clean the equipment. The above system is particularly useful where boiler installations already exist, such as with drilling rig, service rigs, gas plants, etc.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A pressure wash system, comprising in combination:
a heat exchanger having a first fluid path having an inlet and an outlet and a second fluid path having an inlet and an outlet, a heat exchange taking place between the fluids passing along the first fluid path and fluids passing along the second fluid path;
a boiler water circulation loop circulating hot water from a boiler installation along the first fluid path from the inlet to the outlet;
a cold water source upstream of the inlet for the second fluid path of the heat exchanger;
a spray nozzle downstream of the outlet for the second fluid path;
a pump driving water from the cold water source along the second fluid path of the heat exchanger where it is heated by a heat exchange with hot boiler water and delivered under pressure to the spray nozzle.

2. The pressure wash system of claim 1, wherein the heat exchanger comprises:
an elongated vertically orientated cylindrical housing having a bottom, a top, an interior cavity with a boiler water inlet and a boiler water outlet positioned to define the first fluid path through the interior cavity; and
a tubing core positioned within the interior cavity of the housing defining the second fluid path, the tubing core having an inlet through which fluid is fed into the tubing core and an outlet through which fluid exits the tubing core, the second fluid path defined by the tubing core being tortuous to promote a heat exchange with the first fluid path.

3. The pressure wash system of claim 2, wherein the housing further comprises a housing drain at the bottom allowing for gravity drainage of the first fluid path.

4. A method of heating water for use with a spray nozzle, comprising:
circulating hot boiler water from a boiler installation along a first fluid path of a heat exchanger; and
pumping water from a cold water source along a second fluid path of the heat exchanger through a heat exchange with the hot boiler water.
